(19) United States
(12) Patent Application Publication
(10) Pub. No.: US 2026/0194063 A1
(43) Pub. Date: Jul. 9, 2026

(54) SYSTEM, MOTOR, AND MOTOR MANUFACTURING METHOD

(71) Applicant: NIDEC CORPORATION, Kyoto (JP)

(72) Inventor: Hideyuki TAKEMOTO, Kyoto (JP)

(21) Appl. No.: 19/132,821

(22) PCT Filed: Nov. 21, 2023
(86) PCT No.: PCT/JP2023/041743

§ 371 Date: May 26, 2025

(30) Foreign Application Priority Data
Nov. 29, 2022 (JP) 2022-189969

(51) Int. Cl. F04D 27/00; F04D 25/06; F04D 25/08; F04D 25/16

(52) U.S. Cl. CPC F04D 27/004; F04D 25/068; F04D 25/08; F04D 25/166; F05D 2230/60; F05D 2270/023; F05D 2270/62; F05D 2270/80

(57) ABSTRACT

A technique capable of stably operating a system including a plurality of motors is provided. A system includes motors, an impeller attached to an output shaft of each of the motors, and a communication unit and a drive unit corresponding to each of the motors. The communication unit transmits first information indicating the imbalance amount of a first impeller to another communication unit. The first impeller is an impeller corresponding to the communication unit. The communication unit receives second information indicating the imbalance amount of a second impeller from the other communication unit. The second impeller is an impeller corresponding to the other communication unit. The drive unit rotates the motor corresponding to the drive unit at a rotation speed based on the second information received by the communication unit corresponding to the drive unit.

### CROSS-REFERENCE TO RELATED APPLICATIONS

This is the U.S. national stage of application No. PCT/JP2023/041743, filed on Nov. 21, 2023, and priority under 35 U.S.C. § 119 (a) and 35 U.S.C. § 365 (b) is claimed from Japanese Patent Application No. 2022-189969, filed on Nov. 29, 2022.

### FIELD OF THE INVENTION

The present disclosure relates to a system including a plurality of motors, a motor, and a motor manufacturing method.

### BACKGROUND

A system as background art includes a plurality of fan motors. Each of the plurality of fan motors incorporates a first microcomputer having a communication function. The system further includes a second microcomputer having a communication function. Each of the first microcomputers receives an instruction of a rotation speed, forward/reverse rotation, on/off, or the like from the second microcomputer. Each of the first microcomputers controls the operation of the corresponding fan motor in response to the instruction. Each of the first microcomputers can detect a state of a fan motor incorporated therein and notify the second microcomputer of the detected state.

This type of system is required to prevent occurrence of market defects and operate stably.

### SUMMARY

A system according to one aspect of the present disclosure includes a plurality of motors, a rotating body attached to an output shaft of each of the plurality of motors, and a communication unit and a drive unit corresponding to each of the plurality of motors. The communication unit transmits first information indicating the imbalance amount of a first rotating body to another communication unit. The first rotating body is a rotating body corresponding to the communication unit. The communication unit receives second information indicating the imbalance amount of a second rotating body from the other communication unit. The second rotating body is a rotating body corresponding to the other communication unit. The drive units rotates the motor corresponding to the drive unit at a rotation speed based on the second information received by the communication unit corresponding to the drive unit.

A motor according to another aspect of the present disclosure includes an output shaft to which a rotating body is attached, a motor body that rotates the output shaft, a first sensor that detects a rotation speed of the output shaft, a second sensor that detects vibration of the body, and a processing unit that generates first information indicating the imbalance amount of the rotating body on the basis of a detection result of the first sensor and a detection result of the second sensor.

A motor manufacturing method according to still another aspect of the present disclosure includes attaching a rotating body to an output shaft of a motor body, mounting a memory on a board, and storing the imbalance amount of the rotating body in the memory.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram illustrating a configuration of an information processing apparatus including a system according to an embodiment of the present disclosure;

FIG. 2 is a diagram illustrating a first configuration example of each fan illustrated in FIG. 1;

FIG. 3 is a flowchart illustrating an example of operation of a control unit and a communication unit illustrated in FIG. 1;

FIG. 4 is a flowchart illustrating an example of operation of a processing unit and a communication unit illustrated in FIG. 2;

FIG. 5 is a flowchart illustrating detailed processing of step S211 illustrated in FIG. 4;

FIG. 6 is a diagram illustrating a second configuration example of each fan illustrated in FIG. 1; and

FIG. 7 is a diagram illustrating a third configuration example of each fan illustrated in FIG. 1.

### DETAILED DESCRIPTION

Hereinafter, an embodiment of the present disclosure will be described with reference to the drawings. In the drawings, the same or corresponding parts are denoted by the same reference numerals, and the description will not be repeated.

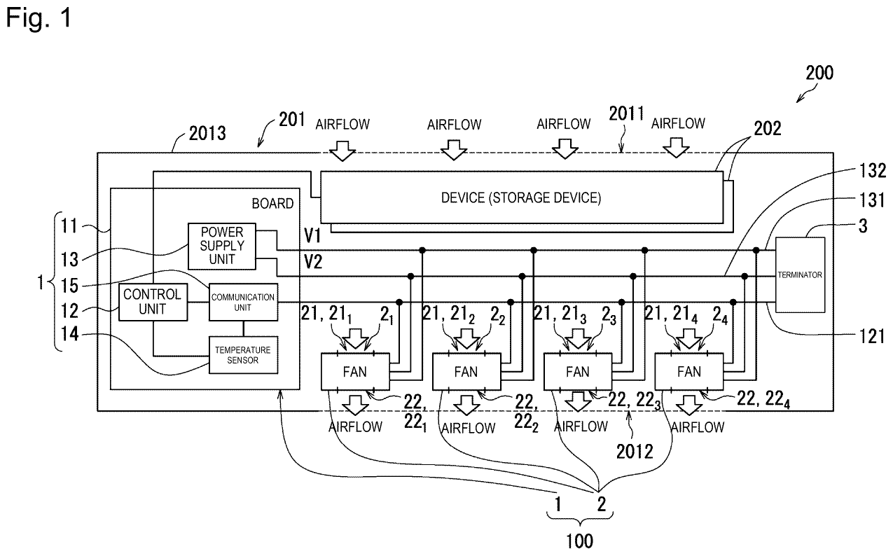

FIG. 1 is a diagram illustrating a configuration of an information processing apparatus 200 including a system 100 according to an embodiment. The information processing apparatus 200 is, for example, a blade server apparatus. As illustrated in FIG. 1, the information processing apparatus 200 includes a housing 201, a plurality of devices 202, and the system 100.

The housing 201 has a substantially rectangular parallelepiped outer shape and has openings 2011 and 2012. The openings 2011 and 2012 are formed at different positions in the housing 201. The opening 2011 functions as an intake port, and the opening 2012 functions as an exhaust port. The housing 201 further includes a frame 2013.

Each device 202 is, for example, a so-called blade, and functions as a single computer device. Specifically, each device 202 includes a microprocessor (not illustrated), a main memory (not illustrated), and a storage device (not illustrated). The storage device is typically a hard disk drive. Each device 202 is attached to the frame 2013. Specifically, each device 202 is located farther from the opening 2012 than the plurality of fans 2 (described later) in the housing 201.

In the embodiment, the information processing apparatus 200 is a blade server apparatus. However, the present invention is not limited thereto, and the information processing apparatus 200 may be, for example, a server device or a RAID device. RAID is an acronym for Redundant Array of Inexpensive Disks. In the case of a server device or a RAID device, each device 202 is a storage device.

The system 100 is an air cooling system in the housing 201. The system 100 includes a circuit board 1 and a plurality of fans 2. The number of fans 2 is four.

The circuit board 1 includes a board 11, a control unit 12, a power supply unit 13, and a temperature sensor 14. The control unit 12, the power supply unit 13, and the temperature sensor 14 are mounted on the board 11.

The control unit 12 typically includes a microprocessor (not illustrated) and a main memory (not illustrated). The microprocessor executes the program stored in the main memory. The control unit 12 is network-connected to each fan 2 by, for example, a data line 121. In the embodiment, the control unit 12 and each fan 2 are connected by a bus-type network topology. Note that the network topology may be of a star type or a ring type. The control unit 12 and each fan 2 may be connected by a wireless network.

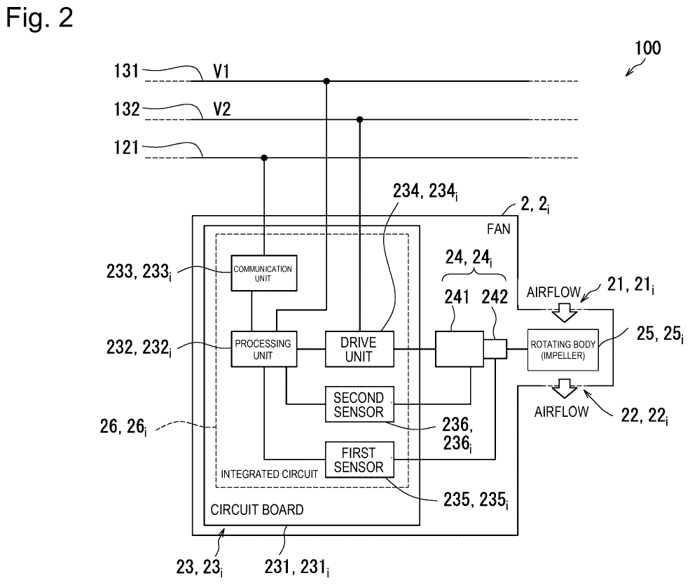

The power supply unit 13 is electrically connected to each fan 2 by power supply lines 131 and 132. The power supply unit 13 receives supply of an AC voltage from, for example, a commercial power supply or an uninterruptible power supply (not illustrated) under the control of the control unit 12. The power supply unit 13 generates DC voltages V1 and V2 for operating each fan 2 from the supplied AC power. The DC voltage V2 is larger than the DC voltage V1. Specifically, the DC voltage V1 is supplied to each fan 2 through the power supply line 131 in order to operate a processing unit 232 and a communication unit 233 (see FIG. 2) of each fan 2. The DC voltage V2 is supplied to a drive unit 234 of each fan 2 through the power supply line 132 in order to rotate the motor 24 (see FIG. 2) of each fan 2.

In addition to the DC voltages V1 and V2, the power supply unit 13 may also generate a voltage (not illustrated) for operating each device 202. That is, the plurality of devices 202 share the power supply unit 13.

A terminator 3 is provided at one end of each of the data line 121 and the power supply lines 131 and 132. The terminator 3 includes a termination resistor of the data line 121, and the like.

The temperature sensor 14 is located near the opening 2012 in the housing 201. Note that the position of the temperature sensor 14 may be either inside or outside the housing 201. The temperature sensor 14 outputs a signal (hereinafter, referred to as a “temperature signal”) indicating the ambient temperature of the temperature sensor 14 to the control unit 12.

The communication unit 15 is a communication interface conforming to a predetermined communication protocol. The predetermined communication protocol is not particularly limited, but is an inter-integrated circuit (I2C) in the embodiment. Although not illustrated, the communication unit 15 operates by the DC voltage V1. The communication unit 15 receives a data packet transmitted through the data line 121 and transfers the data packet to the main memory of the control unit 12. Furthermore, the communication unit 15 transmits the data passed by the control unit 12 to the data line 121 as a data packet.

The plurality of fans 2 are linearly arranged in the housing 201. Each fan 2 has a suction port 21 and a discharge port 22. The plurality of fans 2 are disposed such that air flows between each of the discharge ports 22 and the opening 2012. Specifically, each discharge port 22 faces the opening 2012.

FIG. 2 is a diagram illustrating a first configuration example of each fan 2 illustrated in FIG. 1. Since the fans 2 have substantially the same shape and specification, FIG. 2 illustrates a detailed configuration of one fan 2. In addition, the term “substantially the same” does not mean only completely the same thing, but also generally the same thing with a tolerance or a range of slight differences.

As illustrated in FIG. 2, each fan 2 includes a circuit board 23, a motor 24, and an impeller 25. That is, the system 100 includes a plurality of motors 24. The circuit board 23 includes a processing unit 232, a communication unit 233, a drive unit 234, a first sensor 235, and a second sensor 236 on a board. The processing unit 232, the communication unit 233, the drive unit 234, the first sensor 235, and the second sensor 236 are mounted on the board 231. Therefore, the system 100 includes the processing unit 232, the communication unit 233, the drive unit 234, the first sensor 235, and the second sensor 236 corresponding to each of the plurality of motors 24. The system 100 also includes the impeller 25 corresponding to each of the plurality of motors 24.

The processing unit 232 typically includes a microprocessor (not illustrated) and a main memory (not illustrated). The processing unit 232 operates by the DC voltage V1 supplied through the power supply line 131. The microprocessor operates according to a program stored in the main memory.

The communication unit 233 may be similar to the communication unit 15. Therefore, the description of the communication unit 233 is simplified. The communication unit 233 receives a data packet transmitted through the data line 121 and transfers the data packet to the main memory of the processing unit 232. In addition, the communication unit 233 converts the data passed from the processing unit 232 provided in the same fan 2 into a data packet, and sends the data packet to the data line 121.

Hereinafter, “provided in the same fan 2” may be referred to as “corresponding”. Therefore, for example, the processing units 232 provided in the same fan 2 may be described as “corresponding processing units 232”, and the motor 24 provided in the same fan 2 may be described as “corresponding motor 24”.

When the control unit 12 and each fan 2 are connected by a wireless network, the predetermined communication protocol is a wireless communication standard such as IEEE802.11. In this case, the communication unit 15 and the communication unit 233 operate by the DC voltage V1, receive a data packet transmitted through a wireless transmission path (not illustrated), and transfer the data packet to the main memories of the control unit 12 and the processing unit 232, respectively. Furthermore, the communication unit 15 and the communication unit 233 each convert data transferred from the control unit 12 and the processing unit 232 into a data packet, and transmit the data packet to a wireless transmission path (not illustrated). As a result, since the data line 121 is unnecessary in the housing 201, the space in the housing 201 is effectively used.

The drive unit 234 is typically an H-bridge circuit. The corresponding motor 24 is connected to the drive unit 234. The drive unit 234 includes four switching elements, a power supply terminal, and a grant terminal in order to rotate the corresponding motor 24. Each switching element is, for example, a semiconductor power transistor such as a metal oxide semiconductor field effect transistor. A pulse-width modulated signal (hereinafter, referred to as a “PWM signal”) is input from the processing unit 232 to the gate of each switching element. As a result, on/off of each switching element is controlled, and the DC voltage V2 is chopped by the PWM signal according to the duty ratio of the PWM signal. As a result, the rotation direction and the rotation speed of the motor 24 are controlled.

The motor 24 includes a motor body 241 and an output shaft 242. Each motor body 241 includes a rotor and a stator, and generates a rotating magnetic field under the control of the corresponding drive unit 234. The output shaft 242 is rotated by the rotating magnetic field generated by the motor body 241.

Each of the plurality of impellers 25 is attached to the output shaft 242 of the corresponding motor 24. Therefore, each impeller 25 rotates together with the corresponding output shaft 242. As a result, heat in the housing 201 is discharged to the outside of the housing 201. Specifically, the air around the suction port 21 is sucked into the fan 2 from the suction port 21. The air in the fan 2 is discharged from the discharge port 22 to the outside of the fan 2. As a result, an airflow from the opening 2011 to the opening 2012 is generated in the housing 201. The impeller 25 is an example of a “rotating body” in the present disclosure.

Each of the first sensors 235 is, for example, a rotary encoder, and detects the rotation speed of the output shaft 242 in the corresponding motor 24. Each of the first sensors 235 outputs information indicating the detection result (hereinafter, simply referred to as “rotation speed”) to the corresponding processing unit 232. Each of the second sensors 236 is, for example, a vibration sensor. As the vibration sensor, a piezoelectric sensor is typical. Each of the second sensors 236 detects the vibration frequency of the corresponding motor 24. Each of the second sensors 236 outputs information indicating the detection result (hereinafter, simply referred to as a “vibration frequency”) to the corresponding processing unit 232.

The processing unit 232 can obtain the imbalance amount of the corresponding impeller 25 by the first sensor 235 and the second sensor 236.

Furthermore, as illustrated in FIG. 2, the processing unit 232, the communication unit 233, the drive unit 234, the first sensor 235, and the second sensor 236 provided in the same fan 2 are preferably incorporated in the same integrated circuit 26. As a result, the processing unit 232, the communication unit 233, the drive unit 234, the first sensor 235, and the second sensor 236 can be easily mounted on the board 231. In addition, the fan 2 and thus the system 100 can be downsized.

Next, operations of the control unit 12 and the communication unit 15 (see FIG. 1) and the processing units 232 and the corresponding communication unit 233 (see FIG. 2) in the system 100 will be described with reference to FIGS. 1 to 5.

During operation of the system 100, the control unit 12 (see FIG. 1) acts as a master in the I2C. Each fan 2, that is, each processing unit 232 (see FIG. 2) functions as a slave in the I2C. In addition, the control unit 12 stores the individual address and the broadcast address of each fan 2 in its own memory. The individual address is address information uniquely assigned to each fan 2, that is, the corresponding processing unit 232. The broadcast address is address information for simultaneously distributing data to all the fans 2 connected to the network. Each processing unit 232 stores the individual address of the fan 2 in which it is provided, in its own register.

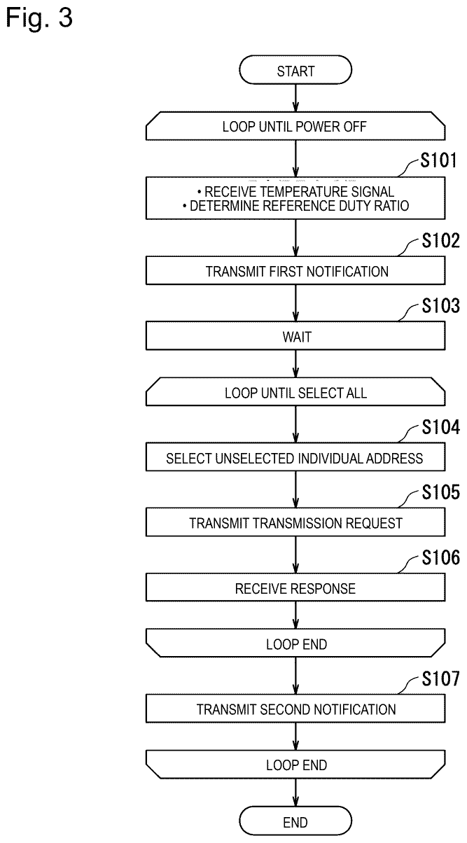

FIG. 3 is a flowchart illustrating an example of operation of the control unit 12 and the communication unit 15 illustrated in FIG. 1. As illustrated in FIG. 3, after starting the information processing apparatus 200, in step S101, the control unit 12 receives a temperature signal from the temperature sensor 14 in order to bring the temperature in the housing 201 close to the set temperature. The control unit 12 determines a duty ratio (hereinafter, referred to as “reference duty ratio”) for compensating for the deviation by PID control based on the deviation (temperature difference) between the temperature indicated by the received temperature signal and the target temperature in the housing 201.

Next, in step S102, the control unit 12 passes the broadcast address, the reference duty ratio, and read/write information to the communication unit 15 as a “first notification”. The read/write information is information indicating either “read” or “write”. When “read” is indicated, the master is the data reception side. When “write” is indicated, the master is the data transmission side. In step S102, “write” as read/write information is passed to the communication unit 15. The communication unit 15 sequentially sends the broadcast address, the read/write information, and the reference duty ratio (that is, the first notification) to the data line 121 bit by bit.

Next, in step S103, the control unit 12 waits for a predetermined time. While waiting, the impeller 25 starts rotation in each of all the fans 2, and eventually rotates steadily. The detailed operation of each fan 2 will be described later.

Next, in step S104, the control unit 12 selects one unselected individual address from all the individual addresses stored in the memory. The control unit 12 sets the individual address selected in step S104 to “selected”.

Next, in step S105, the control unit 12 passes the individual address selected in step S104 and the read/write information indicating “read” to the communication unit 15, as a “transmission request” to the fan 2 specified by the individual address (hereinafter, referred to as a “specific fan 2”). The communication unit 15 sends the transmission request to the data line 121.

Next, in step S106, the control unit 12 receives a response from the specific fan 2. The response is transmitted from the specific fan 2 in response to the transmission request output in step S105, and includes a value indicating the imbalance amount (hereinafter, referred to as “imbalance amount”), the rotation speed, and the vibration frequency. The control unit 12 stores the imbalance amount, the rotation speed, and the vibration frequency included in the received response in the memory.

The control unit 12 repeats a series of processing from step S104 to step S106 until all the individual addresses have been selected in step S104. As a result, the imbalance amounts of all the fans 2 are stored in the memory of the control unit 12.

Next, in step S107, the control unit 12 passes the broadcast address, the imbalance amounts, the rotation speeds, and the vibration frequencies of all the fans 2, and the read/write information indicating “write”, to the communication unit 15 as “second notification”. The communication unit 15 sends the second notification to the data line 121.

Next, after completion of step S107, the control unit 12 waits for an execution timing of the next step S101.

For clarity of the following process description, a suffix i of a variable is assigned to each fan 2 (see FIG. 1). Specifically, each fan 2 may be described as a “fan 2;”. i represents a natural number from 1 to n. n represents the number of fans 2, and is four in the embodiment. In the embodiment, 1, 2, 3, and 4 as the suffix i are allocated to the respective fans 2 in the order of proximity to the circuit board 1 on the data line 121. Therefore, the fan 2 closest to the circuit board 1 is described as a “fan 21”. The second, third, and fourth fans 2 from the circuit board 1 are referred to as a “fan 22”, a “fan 23”, and a “fan 24”, respectively. Furthermore, the corresponding processing units 232 are respectively described as a “processing unit 2321”, a “processing unit 2322”, a “processing unit 2323”, and a “processing unit 2324” (see FIG. 2). A similar suffix i is added to the circuit board 23, the motor 24, the impeller 25, the board 231, the communication unit 233, the drive unit 234, the first sensor 235, and the second sensor 236 (see FIG. 2).

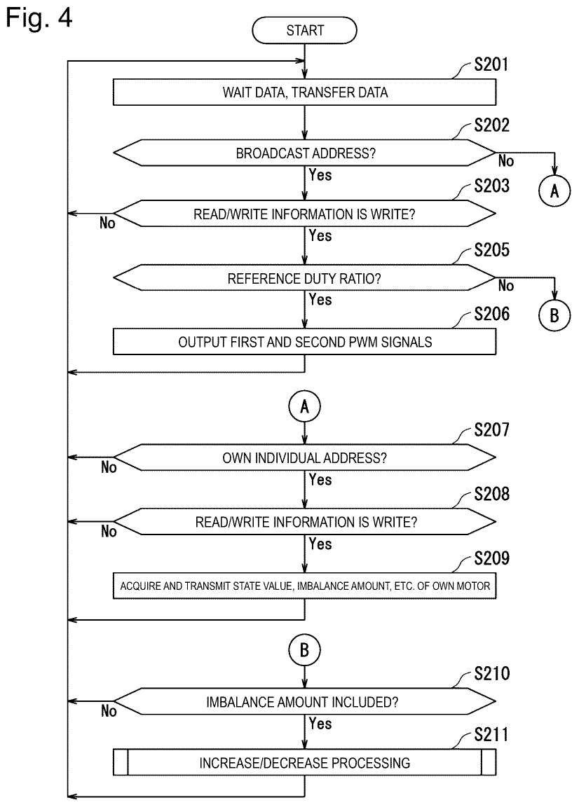

FIG. 4 is a flowchart illustrating an example of operation of the processing unit 232 and the communication unit 233 illustrated in FIG. 2. After starting the information processing apparatus 200, as illustrated in FIG. 4, in step S201, each communication unit 233; waits for data reception from the data line 121. In response to receiving the data, each communication unit 233; transfers the received data to the memory of the processing unit 2321. The processing unit 232; executes the processing in and after step S202 with the data in the memory as a processing target.

In step S202, each processing unit 232; determines whether or not the address information included in the processing target is a broadcast address. When it is determined that the address is the broadcast address (Yes in step S202), step S203 is executed. On the other hand, when it is determined that the address is not the broadcast address (No in step S202), step S207 is executed.

In step S203, the processing unit 232; determines whether or not the read/write information to be processed is “write”. When it is determined not to be “write” (No in step S203), step S201 is executed again. On the other hand, when it is determined to be “write” (Yes in step S203), step S205 is executed.

In step S205, the processing unit 232; determines whether or not the data following the read/write information is the reference duty ratio. When it is determined that the data is the reference duty ratio (Yes in step S205), it is determined that the first notification is received, and step S206 is executed. On the other hand, when it is determined that the data is not the reference duty ratio (No in step S206), step S210 is executed.

In step S206, the processing unit 2321 generates a first PWM signal and a second PWM signal as PWM signals. The first PWM signal has a reference duty ratio. On the other hand, the duty ratio of the second PWM signal is zero. The processing unit 232; applies the first PWM signal to the gates of two predetermined switching elements in the drive unit 234i, and applies the second PWM signal to the gates of the remaining switching elements. As a result, the DC voltage V2 is chopped by the duty ratio of the first PWM signal, and the rotation direction and the rotation speed of the impeller 25; are controlled. As a result, the temperature in the housing 201 can be brought close to the set temperature. After step S206 is executed, step S201 is executed again.

Note that the series of processing from steps S201 to S206 is executed within the waiting time of step S103 (see FIG. 3) in the control unit 12.

In step S207, the processing unit 232; determines whether or not the address information included in the processing target is its own individual address. When it is determined that the address is not its own individual address (No in step S207), step S201 is executed again. On the other hand, when it is determined that the address is its own individual address (Yes in step S207), step S208 is executed.

In step S208, the processing unit 232; determines whether or not the read/write information to be processed is “read”. When it is determined not to be “read” (No in step S208), step S201 is executed again. On the other hand, when it is determined to be “read” (Yes in step S208), step S209 is executed.

In step S209, the processing unit 232; determines that the processing target is the transmission request, and acquires the rotation speed detected by the corresponding first sensor 2351. The processing unit 232; further acquires the vibration frequency detected by the corresponding second sensor 236ᵢ. Next, the processing unit 2321 obtains the imbalance amount of the corresponding impeller 25 by calculating the following Expression (1). That is, the processing unit 232; generates the imbalance amount of the impeller 25 as the first information on the basis of the detection result of the first sensor 235; and the detection result of the second sensor 236ᵢ. This makes it possible to generate information for stably operating the system 100.

$${U}_{i} = {a}_{i} / {S}_{i}^{2} \qquad ( 1 )$$

In the above Expression (1), Uᵢ, Sᵢ, and aᵢ represent as follows. Uᵢ represents the imbalance amount of the impeller 25ᵢ. Sᵢ represents the rotation speed detected by the first sensor 235ᵢ. aᵢ represents a vibration frequency detected by the second sensor 236ᵢ.

In step S209, the processing unit 232; further passes the detected rotation speed and vibration frequency and the obtained imbalance amount to the communication unit 233; as a response to the transmission request. The communication unit 233ᵢ sends the received response to the data line 121. The response is received by the control unit 12 in step S106 (see FIG. 3). As described above, the control unit 12 transmits the imbalance amounts, the rotation speeds, and the vibration frequencies of all the fans 2 to the processing units 232 of all the fans 2 by the second notification. In other words, in step S209, the communication unit 233; transmits the imbalance amount of the impeller 25; and the rotation speed and the vibration frequency of the motor 24; to the communication unit 233 other than the communication unit 233; through the control unit 12 and the communication unit 15. After step S209 is executed, step S201 is executed again.

In step S210, the processing unit 232; determines whether or not the data following the read/write information includes the imbalance amounts of all the fans 2. When it is determined that the data is not the imbalance amounts of all the fans 2 (No in step S210), step S201 is executed again. On the other hand, when it is determined that the data is the imbalance amounts of all the fans 2 (Yes in step S210), it is determined that the second notification has been received, and step S211 is executed. That is, in the case of Yes in step S210, the communication unit 233; receives the imbalance amount of each fan 2 transmitted from the other communication unit 233 through the control unit 12 and the communication unit 15.

In step S211, the processing unit 232; executes processing for increasing or decreasing the rotation speed of the corresponding motor 24; (“increase/decrease processing” in the drawing) based on the imbalance amount of each fan 2 included in the second notification. As a result, the system 100 can be operated stably.

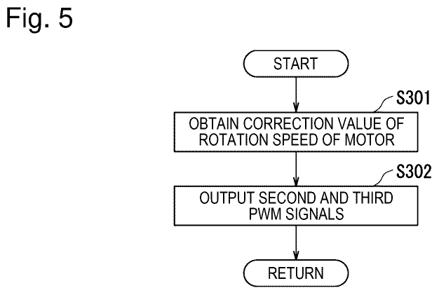

FIG. 5 is a flowchart illustrating detailed processing of step S211 illustrated in FIG. 4.

As illustrated in FIG. 5, when executing step S301, each communication unit 233; has transmitted the imbalance amount (this is an example of “first information” of the present disclosure) of the impeller 25; (an example of the “first impeller” of the present disclosure) corresponding to the communication unit 233ᵢ, to the other communication units 233 except the communication unit 233; in step S209 (see FIG. 4). When step S30ᵢ is executed, each communication unit 233; has received the imbalance amount (this is an example of “second information” of the present disclosure) of each impeller 25 (an example of the “second impeller” of the present disclosure) corresponding to each of the other communication units 233 from the other communication unit 233 except for the communication unit 233; in step S201 (see FIG. 4). Therefore, at the start of execution of step S301, the memory of the processing unit 232; stores therein the imbalance amount, the rotation speed, and the vibration frequency of each of the n fans 2.

In step S301, the processing unit 232ᵢ calculates the following Expression (2) to obtain the correction value of the rotation speed of the motor 24ᵢ.

$$[ Mathematical Formula 1 ]$$

$${C}_{i} = {S}_{target} \cdot \sqrt{\frac{{U}_{ave}}{{U}_{i}}} \cdot k \qquad ( 2 )$$

$$k = \frac{n}{{\sum }_{i = 1}^{n} \sqrt{\frac{{U}_{ave}}{{U}_{i}}}} \qquad ( 3 )$$

In the above Expression (2), Cᵢ, S_{target}, Uₐᵥₑ, and n represent as follows. Cᵢ represents a correction value of the rotation speed of the motor 24ᵢ (that is, the impeller 25ᵢ). S_{target} represents a rotation speed of an ideal motor 24ᵢ in a case where a PWM signal having a reference duty ratio is given. The Ideal motor 24ᵢ is motor 24ᵢ having an imbalance amount of 0. Uₐᵥₑ represents an average value of the imbalance amounts of the n fans 2. Note that n is 4 in the embodiment.

In step S302, the processing unit 232ᵢ generates a third PWM signal and the above-described second PWM signal as PWM signals. The third PWM signal has a duty ratio (hereinafter, referred to as “correction value of the duty ratio”) corresponding to the correction value of the rotation speed of the motor 24ᵢ. The processing unit 232ᵢ applies the third PWM signal to the gates of two predetermined switching elements (described above) in the corresponding drive unit 234ᵢ, and applies the second PWM signal to the gates of the remaining switching elements.

Therefore, each drive unit 234ᵢ rotates the motor 24ᵢ at the rotation speed based on the imbalance amount (that is, the second information) of the impeller 25 received by the corresponding communication unit 233; and corresponding to the communication unit 233 other than the communication unit 233ᵢ. This enables the system 100 to operate stably for a long period of time.

In the embodiment, the impeller 25 is attached to the output shaft of each motor 24. In this case, the cooling performance of the system 100 can be maintained by the processing of steps S301 and S302.

More specifically, according to step S302, when the imbalance amount (that is, the first information) of the corresponding impeller 25ᵢ is smaller than the imbalance amount (that is, the second information) of the other impellers 25, each of the processing units 232ᵢ causes the corresponding drive unit 234ᵢ to increase the rotation speed of the corresponding motor 24ᵢ. This processing is an example of “first processing” in the present disclosure.

On the other hand, according to step S302, when the imbalance amount (that is, the first information) of the corresponding impeller 25; is larger than the imbalance amount (that is, the second information) of the other impellers 25, each of the processing units 232; causes the corresponding drive unit 234ᵢ to decrease the rotation speed of the corresponding motor 24ᵢ. This processing is an example of “second processing” in the present disclosure.

According to the above Expression (2), the increase amount of the rotation speed is determined based on the decrease amount of the rotation speed.

Therefore, even if the vibration frequencies of the motors 24₁ to 24₄ vary due to the imbalance amounts of the respective impellers 25₁ to 25₄ immediately after the execution of step S206, the vibration frequencies of the motors 24₁ to 24₄ can be substantially the same immediately after the execution of step S302. Moreover, the total rotation speed of the impellers 25₁ to 25₄ immediately after the execution of step S206 can be substantially the same immediately after the execution of step S302. As a result, it is possible to provide the system 100 capable of preventing occurrence of a market defect in advance and stably operating.

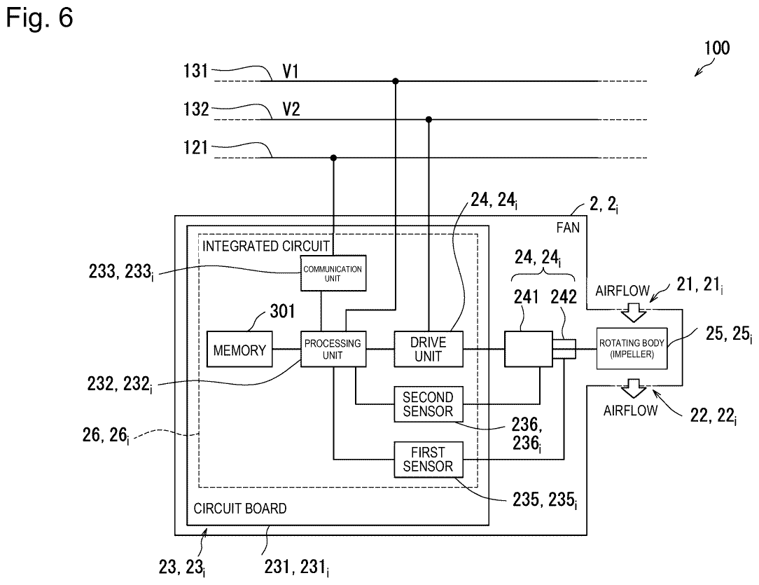

FIG. 6 is a diagram illustrating a second configuration example of each fan 2 illustrated in FIG. 1. As illustrated in FIG. 6, each fan 2 is different from the configuration illustrated in FIG. 2 in further including a memory 301. The memory 301 is, for example, a non-volatile memory such as a flash memory, and is mounted on the circuit board 23. Therefore, the memory 301 corresponds to each of the plurality of motors 24. The memory 301 is an example of a “storage unit” in the present disclosure. As is apparent from the above description, in step S209 in FIG. 4, the processing unit 232 generates the imbalance amount (that is, first information) of the impeller 25 based on the detection result of the corresponding first sensor 235 and the detection result of the corresponding second sensor 236. Thus, the processing unit 232 can recognize the temporal change of the imbalance amount.

In step S209 (see FIG. 4), the processing unit 232 stores the imbalance amount obtained by itself in the corresponding memory 301. The communication unit 233 transmits the imbalance amount stored in the corresponding memory 301 to the other communication unit 223.

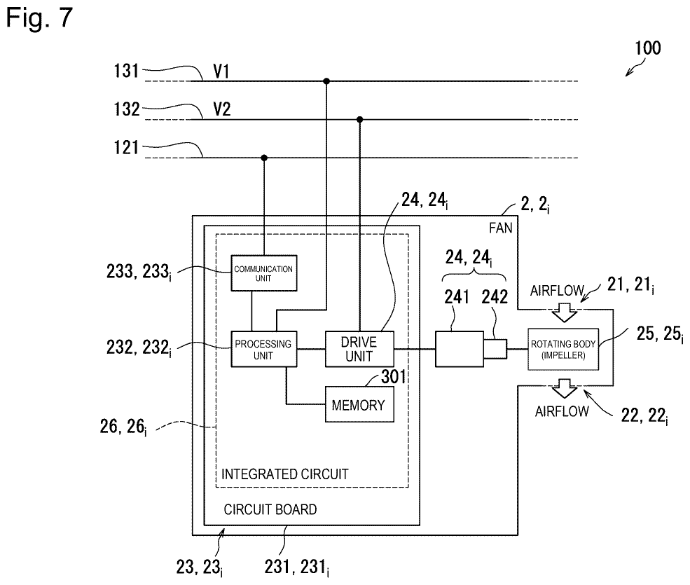

FIG. 7 is a diagram illustrating a third configuration example of each fan 2 illustrated in FIG. 1. As illustrated in FIG. 7, each fan 2 is different from the configuration illustrated in FIG. 2 in that a memory 301 is provided instead of the first sensor 235 and the second sensor 236.

A manufacturing step of each fan 2 will be described in detail with reference to FIG. 7. The manufacturing step generally includes a first step and a second step. In the manufacturing step, the fan 2 is manufactured. Specifically, in the first step, the impeller 25ᵢ is attached to the output shaft 242 of each motor 24ᵢ. In the second step, the first sensor 235ᵢ, the second sensor 236ᵢ, and the memory 301 are mounted on the board of the circuit board 23ᵢ. All the fans 2 manufactured in the manufacturing step are inspected in the inspection step.

In the inspection step, an inspection apparatus measures a vibration value when each fan 2 is operated at a predetermined rotation speed. The inspection device also derives the imbalance amount from the measurement value and stores the imbalance amount in the memory 301. Consequently, the processing unit 232 can acquire the imbalance amount from the corresponding memory 301 even if the first sensor 235 and the second sensor 236 are not provided.

In the third exemplary configuration, the processing unit 232 acquires the imbalance amount from the corresponding memory 301 instead of acquiring the imbalance amount by the calculation in step S209 of FIG. 4. The communication unit 233 transmits the imbalance amount (first information) acquired by the processing unit 232 to the other communication unit 233 by the second notification.

The embodiment of the present disclosure is described above with reference to the drawings. However, the present disclosure is not limited to the above embodiment, and can be implemented in various modes without departing from the gist of the present disclosure. Further, a plurality of constituent elements disclosed in the above embodiment can be appropriately modified. For example, a certain constituent element of all constituent elements illustrated in a certain embodiment may be added to constituent elements of another embodiment, or some constituent elements of all constituent elements illustrated in a certain embodiment may be removed from the embodiment.

The drawings schematically show each component mainly in order to facilitate understanding of the present disclosure, and the thickness, length, number, interval, and the like of each component that is shown may be different from the actual ones for convenience of the drawings. The configuration of each component shown in the above embodiment is an example and is not particularly limited, and it goes without saying that various modifications can be made without substantially departing from the effects of the present disclosure.

In the embodiment, the case where the system 100 is applied to the information processing apparatus 200 has been described. However, the present invention is not limited thereto, and the system 100 may be applied to a roller conveyor. A roller conveyor is a device in which a plurality of rotating bodies (rollers) are arranged and fixed at a right angle between a pair of frames, and a conveyance object is placed and moved on the plurality of rotating bodies. In this case, not the impeller 25 but a roller is attached to the output shaft of each motor 24.

In the embodiment, data communication based on the I2C has been performed in the system 100. However, the data communication may be performed by a communication protocol other than the I2C.

In the embodiment, in the system 100, the communication unit 233 transmits data to the other communication unit 233 via the control unit 12 as a master. However, the present invention is not limited thereto, and in a case where the slave-to-slave communication can be executed, the communication unit 233 may directly transmit data to another communication unit 233.

The present technology can also adopt the following configurations.

(1) A system including:
a plurality of motors;
a rotating body attached to an output shaft of each of the plurality of motors; and
a communication unit and a drive unit corresponding to each of the plurality of motors,
in which the communication unit:
   transmits first information indicating an imbalance amount of a first rotating body to another communication unit, the first rotating body being the rotating body corresponding to the communication unit; and
   receives second information indicating an imbalance amount of a second rotating body from the other communication unit, the second rotating body being the rotating body corresponding to the other communication unit, and
the drive unit rotates one of the plurality of motors corresponding to the drive unit at a rotation speed based on the second information received by the communication unit corresponding to the drive unit.

(2) The system according to (1), in which the rotating body is an impeller.

(3) The system according to (1) or (2), further including a processing unit corresponding to each of the plurality of motors,
in which the processing unit:
   executes first processing for causing the drive unit corresponding to the processing unit to increase the rotation speed of the motor corresponding to the drive unit, when the imbalance amount indicated by the first information is smaller than the imbalance amount indicated by the second information; and
   executes second processing for causing the drive unit corresponding to the processing unit to decrease the rotation speed of the motor corresponding to the drive unit, when the imbalance amount indicated by the first information is larger than the imbalance amount indicated by the second information.

(4) The system according to (3), in which the rotation speed increased by the first processing is determined based on the rotation speed decreased by the second processing.

(5) The system according to any one of (1) or (4), further including a storage unit corresponding to each of the plurality of motors,
in which the storage unit stores the first information indicating the imbalance amount of the first rotating body corresponding to the storage unit, and
the communication unit transmits the first information, stored in the storage unit corresponding to the communication unit, to the other communication unit.

(6) The system according to any one of (1) or (5), further including a first sensor, a second sensor, and a processing unit corresponding to each of the plurality of motors,
in which the first sensor detects a rotation speed of the motor corresponding to the first sensor,
the second sensor detects a vibration frequency of the motor corresponding to the second sensor,
the processing unit generates the first information indicating the imbalance amount of the first rotating body corresponding to the processing unit on a basis of a detection result of the first sensor and a detection result of the second sensor corresponding to the processing unit, and
the communication unit transmits the first information generated by the processing unit corresponding to the communication unit to the other communication unit.

(7) The system according to any one of (1) to (6), further including a storage unit corresponding to each of the plurality of motors,
in which the storage unit stores the first information generated by the processing unit corresponding to the storage unit.

(8) A motor including:
an output shaft to which a rotating body is attached;
a motor body that rotates the output shaft;
a first sensor that detects a rotation speed of the output shaft;
a second sensor that detects vibration of the body; and
a processing unit that generates first information indicating an imbalance amount of the rotating body on a basis of a detection result of the first sensor and a detection result of the second sensor.

(9) A motor manufacturing method including:
attaching a rotating body to an output shaft of a motor body;
mounting a memory on a board; and
storing an imbalance amount of the rotating body in the memory.

The system, the motor, and the motor manufacturing method according to the present disclosure have industrial applicability.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A system comprising:
a plurality of motors;
a rotating body attached to an output shaft of each of the plurality of motors; and
a communication unit and a drive unit corresponding to each of the plurality of motors,
wherein the communication unit:
transmits first information indicating an imbalance amount of a first rotating body to another communication unit, the first rotating body being the rotating body corresponding to the communication unit; and
receives second information indicating an imbalance amount of a second rotating body from the other communication unit, the second rotating body being the rotating body corresponding to the other communication unit, and
the drive unit rotates one of the plurality of motors corresponding to the drive unit at a rotation speed based on the second information received by the communication unit corresponding to the drive unit.

2. The system according to claim 1, wherein the rotating body is an impeller.

3. The system according to claim 1, further comprising a processing unit corresponding to each of the plurality of motors,
wherein the processing unit:
executes first processing for causing the drive unit corresponding to the processing unit to increase the rotation speed of the motor corresponding to the drive unit, when the imbalance amount indicated by the first information is smaller than the imbalance amount indicated by the second information; and
executes second processing for causing the drive unit corresponding to the processing unit to decrease the rotation speed of the motor corresponding to the drive unit, when the imbalance amount indicated by the first information is larger than the imbalance amount indicated by the second information.

4. The system according to claim 3, wherein the rotation speed increased by the first processing is determined based on the rotation speed decreased by the second processing.

5. The system according to claim 1, further comprising a storage unit corresponding to each of the plurality of motors,
wherein the storage unit stores the first information indicating the imbalance amount of the first rotating body corresponding to the storage unit, and
the communication unit transmits the first information, stored in the storage unit corresponding to the communication unit, to the other communication unit.

6. The system according to claim 1, further comprising a first sensor, a second sensor, and a processing unit corresponding to each of the plurality of motors,
wherein the first sensor detects a rotation speed of the motor corresponding to the first sensor,
the second sensor detects a vibration frequency of the motor corresponding to the second sensor,
the processing unit generates the first information indicating the imbalance amount of the first rotating body corresponding to the processing unit on a basis of a detection result of the first sensor and a detection result of the second sensor corresponding to the processing unit, and
the communication unit transmits the first information generated by the processing unit corresponding to the communication unit to the other communication unit.

7. The system according to claim 6, further comprising a storage unit corresponding to each of the plurality of motors,
wherein the storage unit stores the first information generated by the processing unit corresponding to the storage unit.

8. A motor comprising:
an output shaft to which a rotating body is attached;
a motor body that rotates the output shaft;
a first sensor that detects a rotation speed of the output shaft;
a second sensor that detects vibration of the body; and
a processing unit that generates first information indicating an imbalance amount of the rotating body on a basis of a detection result of the first sensor and a detection result of the second sensor.

9. A motor manufacturing method comprising:
attaching a rotating body to an output shaft of a motor body;
mounting a memory on a board; and
storing an imbalance amount of the rotating body in the memory.
